(19) United States
(12) Patent Application Publication
(10) Pub. No.: US 2026/0190098 A1
(43) Pub. Date: Jul. 2, 2026

(54) CARRIER AGGREGATION OPTIMIZATION

(71) Applicant: T-Mobile USA, Inc., Bellevue, WA (US)

(72) Inventors: Roopesh Kumar Polaganga, Bothell, WA (US); Sirisha Potlabathini, Reston, VA (US)

(21) Appl. No.: 19/006,975

(22) Filed: Dec. 31, 2024

(51) Int. Cl. H04W 72/0453; H04L 5/00

(52) U.S. Cl. CPC H04W 72/0453; H04L 5/001

(57) ABSTRACT

Carrier aggregation is used to increase throughput rates provided to devices in wireless telecommunications networks. However, certain devices are limited in their ability to utilize carrier aggregation. The approaches described herein can enable optimized carrier aggregation. Carrier aggregation can be optimized by handing off a device such that it is connected to the wireless telecommunication network using a channel bandwidth that is supported by the device for certain carrier aggregation configurations. In some implementations, the approaches herein consider factors such as available capacity, coverage areas of cell sites, and/or demands of one or more devices connected to a cell when determining whether to handoff a device to enable the device to take greater advantage of carrier aggregation.

### BACKGROUND

Carrier aggregation is a technique used in wireless telecommunications networks to increase throughput to users. In some cases, carrier aggregation can be used to improve reliability. In carrier aggregation, multiple frequency blocks (component carriers) are used for the same device (e.g., a smartphone) that is connected to a wireless telecommunications network. Assigning more carriers increases the total bandwidth available to a given device.

Carrier aggregation can occur within a single band (intra-band carrier aggregation) or across multiple frequency bands (inter-band carrier aggregation). Carrier aggregation can work in time division duplex (TDD) or frequency division duplex (FDD) modes. Both TDD and FDD can be utilized by the same device.

Carrier aggregation offers benefits to both wireless telecommunications network operators and users of such networks. Users can experience improved service, such as increased data rates or better coverage, and network operators can better optimize their networks and better utilize their spectrum. As an example, network operators can use carrier aggregation as a tool for load balancing, quality of service management, prioritization of certain traffic or certain users, and so forth.

Carrier aggregation is dependent upon both the capabilities of the network and the capabilities of user devices such as smartphones. Current approaches to carrier aggregation have limitations. Accordingly, there is a need for improved approaches to carrier aggregation.

### BRIEF DESCRIPTION OF THE DRAWINGS

Detailed descriptions of implementations of the present invention will be described and explained through the use of the accompanying drawings.

FIG. 1 is a block diagram that illustrates a wireless telecommunication network in which aspects of the disclosed technology are incorporated.

FIG. 2 is a block diagram that illustrates an architecture including 5G core network functions that can implement aspects of the present technology.

FIG. 3 is a diagram that schematically illustrates bandwidth parts (BWPs) according to some implementations.

FIG. 4 is a table that shows examples of intra-band NRCA configurations for the N41 band.

FIG. 5 is a drawing that schematically illustrates three component carrier aggregation according to some implementations.

FIG. 6 is a drawing that schematically illustrates four component carrier aggregation according to some implementations.

FIG. 7 is a diagram that schematically illustrates NRCA for devices with different supported bandwidth combination sets according to some implementations.

FIG. 8 is a flowchart that illustrates an example NRCA process according to some implementations.

FIG. 9 is a flowchart that illustrates an example process for determining which of a plurality of user devices to hand off to a target cell to facilitate carrier aggregation.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Carrier aggregation is a technology that enables multiple carriers to be utilized in combination in order to increase the overall bandwidth and performance provided by a wireless telecommunications network to a user equipment device (e.g., a smartphone). Carrier aggregation can result in higher data rates, improved coverage, or both. Other advantages may also be realized. In 5G networks, carrier aggregation can be used to improve data rates and enable low latency, which can be important for applications such as multiplayer gaming, video conferencing, virtual reality, autonomous vehicles, large file downloads, and so forth. While described herein largely in relation to cellular networks, and in particular in relation to 5G cellular networks, it will be appreciated that the techniques herein are not limited to such networks. The approaches described herein can be applied to other types of wireless networks including, for example, non-terrestrial networks such as satellite networks, balloon-based networks, and so forth. The approaches herein can also be applied to other types of cellular networks and are not limited to 5G networks.

Carrier aggregation can also be important for improving and/or managing network capacity. For example, by aggregating multiple carriers, a wireless telecommunications network (e.g., a 5G network) can handle more devices and traffic simultaneously and/or better manage network resources, which may be limited. This can be especially significant in areas with a high density of users, during peak usage times, and so forth. Carrier aggregation can help to ensure that the network remains responsive even under significant loads.

Carrier aggregation can also be used to improve network coverage experienced by users. Different frequency bands have different propagation characteristics and thus perform differently in different circumstances. For example, low frequencies tend to propagate longer distances and are less impacted by physical obstacles, interference, and so forth. However, lower frequencies are also generally associated with slower data rates. Higher frequencies generally offer greater throughput but are more strongly impacted by interference and obstacles. Thus, for example, at large distances from a cell site, performance at higher frequencies may be more significantly diminished or may even be unavailable while lower frequencies still provide good coverage. By combining multiple carriers, carrier aggregation can help fill coverage gaps and ensure that users have consistent connectivity even in challenging environments.

In 5G networks, carrier aggregation can be referred to as New Radio Carrier Aggregation (NRCA). There are two primary types of NRCA: intra-band and inter-band. Intra-band carrier aggregation involves combining carriers within the same frequency band. This can be useful for various purposes, such as increasing capacity in areas with limited spectrum availability. Intra-band carrier aggregation can be further divided into contiguous intra-band carrier aggregation (wherein the spectrum of the component carriers is contiguous) and non-contiguous intra-band carrier aggregation(wherein the component carriers are in the same band but separated by a gap in the spectrum). Inter-band carrier aggregation involves combining carriers from different frequency bands, which can, for example, improve coverage and/or increase bandwidth available to users. Depending upon the implementation, inter-band carrier aggregation can utilize bands that all have the same duplex mode (e.g., all frequency division duplex (FDD) mode or all time division duplex (TDD) mode) or can utilize a mix of duplex modes (e.g., a combination of TDD and FDD modes). Carriers often have access to both FDD and TDD spectrum. Thus, carriers can more fully realize the capabilities of their spectrum by aggregating both FDD and TDD.

While NRCA is a powerful technology, there are certain limitations. Not all base stations support all carrier aggregation configurations, nor do all devices (e.g., smartphones) support all carrier aggregation configurations. In particular, certain devices only support certain carrier aggregations or certain bandwidth combination sets (BCSs). Bandwidth combination set (BCS) can refer to groupings of frequency bands that a device can use simultaneously for communication. The individual carriers that are combined in aggregation can be referred to as component carriers. Each component carrier can have a bandwidth that defines a width of a range of frequencies utilized by the component carrier. Different devices support different numbers of component carriers. Different carrier components can have different duplex modes or the same duplex mode (e.g., TDD or FDD).

As an example, some older cellular modems, which are still widely used, may have limitations that prevent certain carrier aggregation configurations from working. For example, certain legacy devices only support BCS-1 on the N41 band. When such devices connect using 70 MHz bandwidth, they are unable to utilize intra-band carrier aggregation in the N41 band. This can cause such devices to be unable to take advantage of significant bandwidth that may otherwise be available. Different modems can have different capabilities. For example, different modems may support differing numbers of carriers, different frequency bands, support different bandwidths, and so forth. It can be important to understand the capabilities of particular modems in order to optimize the carrier aggregation that a wireless telecommunications network uses with devices having different modems. Devices with limited capabilities can become of increasing importance as networks are improved but older devices that cannot fully take advantage of the improvements are still in widespread use. As the market for smartphones matures, individuals may keep their devices for longer periods of time, thus increasing the number of older smartphones on a network.

In some cases, a device may attach using a channel bandwidth that enables only limited or no carrier aggregation. For example, the device may only be able to utilize inter-band carrier aggregation but not intra-band carrier aggregation. In this disclosure, such bandwidths are referred to as “odd” bandwidths. This can result in relatively poor performance for devices that attach using odd bandwidths that are not included in certain bandwidth combination sets. If those devices can be transitioned to another bandwidth, NRCA can be more effective and can be used to increase peak throughput performance beyond what is supported when a device is connected using the odd bandwidth. In some implementations, a base station (e.g., gNodeB) can be configured to automatically transition certain devices based on their capabilities. A base station typically has awareness of the capabilities of a device, which can be obtained, for example, during an attachment process or otherwise. In some implementations, a device directly provides information about its capabilities. In other implementations, a base station or other network component or system operating by a wireless telecommunications network operator uses certain information about a device (e.g., a device identifier) and queries a dataset to determine the capabilities of the device. As described herein, other considerations can also be used in determining whether or not to transition to a different bandwidth, such as current load, available capacity, coverage, etc.

In carrier aggregation, differing numbers of component carriers (CCs) can be utilized to allow multiple frequency bands to be used. For example, in 2 CC carrier aggregation, two component carriers are used, while 3 CC and 4 CC aggregate three and four carriers, respectively. A higher number of component carriers enables increases in data rate. However, a higher number of component carriers can also reduce the total amount of bandwidth available for data transmission due to reservation of guard bands between sub-blocks and other overhead associated with carrier aggregation. The number of component carriers is not necessarily limited. For example, there can be five, six, seven, eight, or more component carriers.

While NRCA can provide significant benefits to devices, the benefits that are realized from NRCA can vary depending upon factors such as the load on a cell site, coverage area, and so forth. A naïve approach to NRCA is to simply aggregate whenever possible. However, this may confer little or no benefit if cells are already experiencing high loads or handing a device off from one cell to another would negatively impact the area over which a device has coverage. Thus, it can be important to consider not only whether aggregation is possible, but whether there is expected to be a significant benefit to doing so. The effects of aggregation, such as increasing utilization, can also be considered to ensure that the overall performance of a network or cell site is not unacceptably impacted. The approaches described herein can address limitations and challenges associated with carrier aggregation, resulting in higher bandwidth for certain devices that otherwise would be unable to take advantage of certain carrier aggregation configurations. The approaches described herein can optimize carrier aggregation for both devices and a wireless telecommunications network.

In some implementations of the disclosed technology, a wireless telecommunications network can use an internal algorithm to determine the best cell set across co-located cells for carrier aggregation. Such an internal algorithm can be executed at a base station or by some other component of the network or that is in communication with the network. Determining whether or not to perform certain carrier aggregation operations and, if so, the desired carrier aggregation configuration, can depend upon a variety of factors, such as whether or not a device is currently constrained by its carrier aggregation configuration (e.g., whether or not the device can utilize more bandwidth than it can currently access), availability of bandwidth within cell sets, coverage areas of different cell sets, and so forth.

Bandwidth part (BWP) is a technique utilized in some networks, such as 5G networks) that can improve the efficiency, flexibility, or both of spectrum usage. BWP enables a device to operate over a subset of the total carrier bandwidth. BWP can offer several advantages. For example, using BWP can improve power efficiency as a narrower bandwidth can be optimized for lower power consumption, which can help improve battery life of connected devices. BWP can be used to optimize resource allocation for different devices and applications. For example, a device that is doing high bandwidth activity such as video streaming can be assigned a wider BWP, while narrower BWP can be used for devices that are consuming limited resources conducting activities such as messaging, web browsing, or music streaming. BWPs can be particularly beneficial for internet of things (IoT) devices, as narrow bandwidth can allow such devices to operate efficiently on the network with low power consumption.

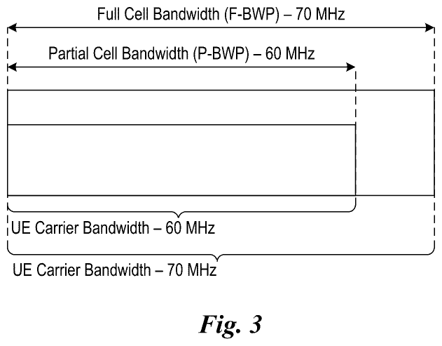

In some implementations, the subset can be dynamically adjusted based on network conditions, capabilities of devices, and so forth. BWP can be utilized in various scenarios, such as to reduce power consumption when full carrier bandwidth is not needed. In some implementations, a carrier utilizes BWP for network management, for example to allocate different BWPs to different types of traffic. As described herein, BWP can be used to enable improved carrier aggregation, for example by transitioning a device from full bandwidth (which may limit aggregation) to partial bandwidth, which can enable greater carrier aggregation. As an example, a device that supports only BCS-1 for N41 and which connects at 70 MHz channel bandwidth cannot aggregate other N41 carriers as such aggregation is not supported. However, if the device connects at 60 MHz, this is supported for carrier aggregation, and thus, for example, the 60 MHz carrier can be aggregated with a 100 MHz carrier. Specific examples are illustrated in more detail herein, for example with respect to FIG. 3.

Network resources are often limited, and different devices (e.g., smartphones) may have different limitations. It can be important to prioritize handovers and so forth in order to optimize performance across devices. For example, if a BCS-1-limited device and a BCS-4-limited device are connected to a primary cell (PCell) at 70 MHz, and a target cell has available capacity at 60 MHz sufficient for one device but not both, an internal algorithm can prioritize the BCS-1 device for handoff to the target cell. For example, a BCS-1-limited device connected to the PCell at 70 MHz can be handed off to a target cell at 60 MHz, which can then be aggregated with 100 MHz for a total bandwidth of 160 MHz, while the BCS-4-limited can remain on the PCell and utilize 70 MHz aggregated with 100 MHz, for a total of 170 Mhz.

In some implementations, multiple limited devices may be connected to the same serving cell. A target cell may have capacity for some, but not all, of the devices. In some implementations, the wireless telecommunications network can prioritize devices based on, for example, their current demands, historical demands, and/or the like. For example, devices that are placing relatively high demands on the network (e.g., by streaming video) can be prioritized over devices that are placing lower demands, such as web browsing or streaming music at relatively low bit rates.

The approaches described herein can be used to achieve greater carrier aggregation (e.g., higher total bandwidth) for a device. However, carrier aggregation does not necessarily mean that a device actually experiences improved performance. For example, weak signal strength in one or more of the aggregated carriers can result in a negative impact on overall network performance of a device, certain carriers may already be carrying a large amount of traffic and thus may have little spare throughput to dedicate to another device, and so forth. Moreover, if a user is not using significant data, the user may not perceive any benefit from higher speeds or throughput capacities. Performing aggregations, handoffs, and so forth can have a significant power cost for devices. Thus, it can be significant to only carry out such operations when there is or is expected to be a significant benefit to doing so.

In some implementations, a base station (e.g., gNodeB) can determine if a limited capability device has buffer usage above a threshold amount. For example, data can be buffered until it can be delivered to the device. If not, there may be little or no benefit to additional carrier aggregation, and thus measures to increase the total bandwidth available to the device may not be taken. For example, a user who is not actively using their device or who is only using their device for web browsing, e-mailing, or instant messaging may see little or no benefit from increased total bandwidth, while a user who is streaming video, on a video call, downloading a large file, etc., may experience a noticeable improvement in performance of the network with greater carrier aggregation and greater total available bandwidth. If it is determined that a device could benefit from carrier aggregation adjustments, a network can identify a best cell set or sets across cells (e.g., co-located cells). If the available bandwidth of the best cell set or sets is above a threshold value, there may be benefits to adjusting carrier aggregation. If not, changing carrier aggregation may confer little or no benefit to the user. Coverage of cell sets can also be an important consideration. For example, while it may be possible to provide greater bandwidth to a device, it may not be worthwhile to do so if the coverage would be reduced, which could limit the amount of time the device can derive benefits from improved aggregation, can increase power consumption of the device as more handovers are carried out, and so forth. If there are significant benefits and limited drawbacks or other limitations on changing carrier aggregation, the device can be handed off to a different primary cell (PCell) and new carrier aggregation can be assigned.

### Wireless Communications System

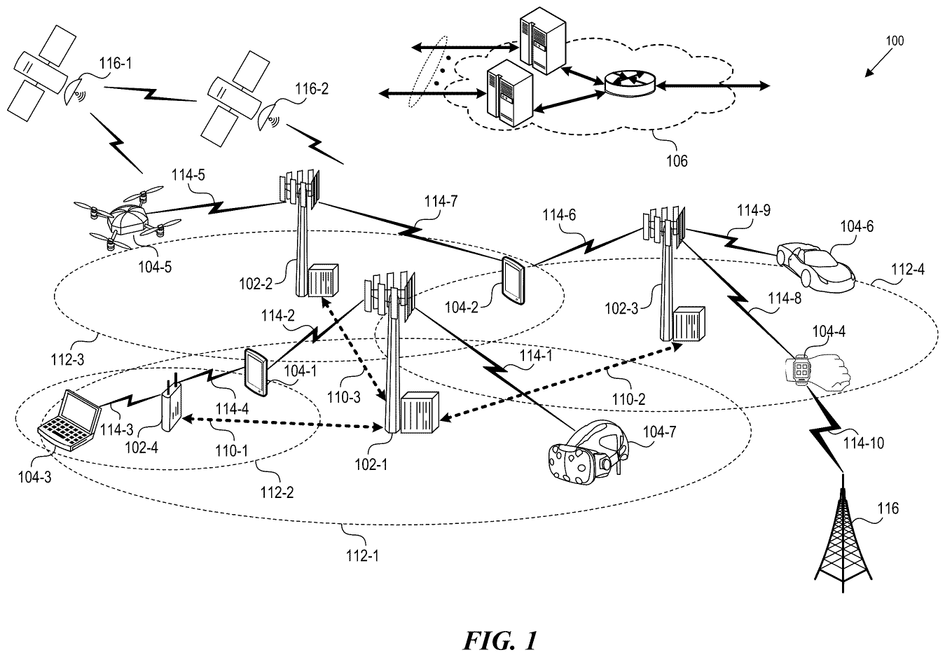

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

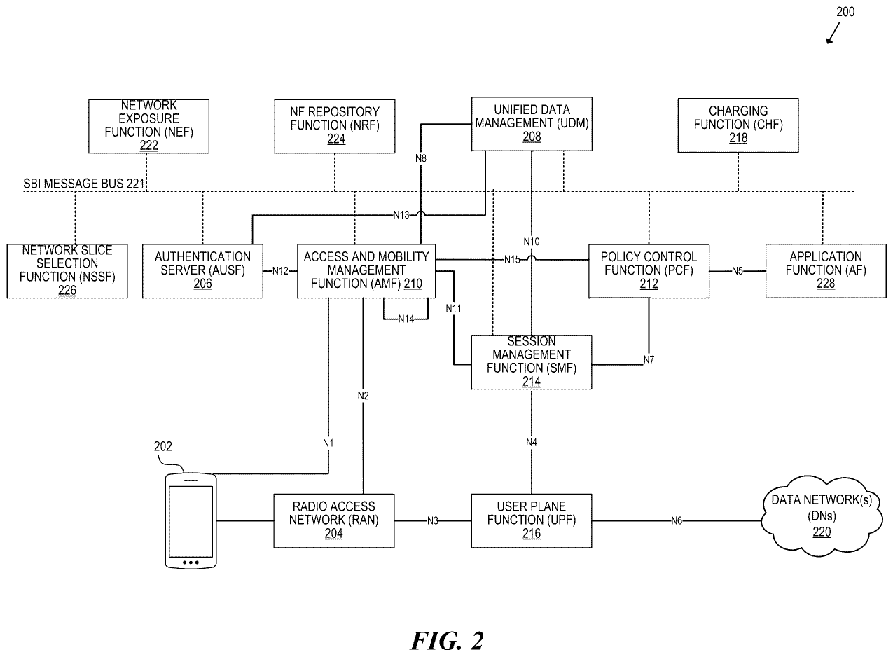

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Implementations

FIG. 3 is a diagram that schematically illustrates bandwidth parts (BWPs) for an n41 band according to some implementations. In FIG. 3, a cell has a full bandwidth (F-BWP) of 70 MHz and a partial bandwidth (P-BWP) of 60 Mhz. As shown in FIG. 3, user equipment can attach at either 60 MHz or 70 MHz. Whether a UE utilizes 60 MHz or 70 MHz can depend upon the particular UE, for example on its carrier aggregation capabilities. In some cases, a BCS-1 limited device can connect at 70 MHz, but due to bandwidth combination set constraints, will be unable to utilize intra-band carrier aggregation and thus be limited to 70 MHz only in the N41 band.

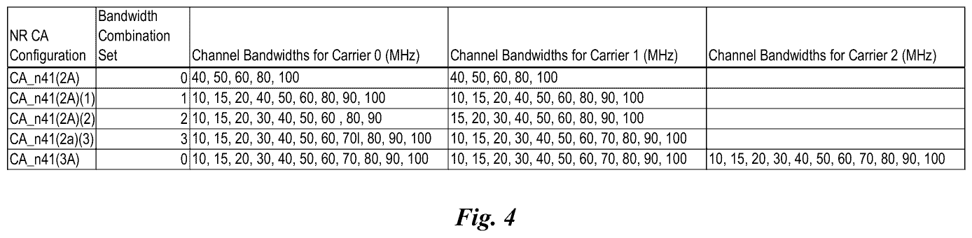

FIG. 4 is a table that shows examples of intra-band NRCA configurations for the 41 band. As shown in FIG. 4, devices limited to BCS 1 do not support intra-band carrier aggregation using a channel bandwidth of 70 MHz. Thus, if a BCS 1 device is connected to a cell site (e.g., a gNodeB) at 70 MHz channel bandwidth, the BCS 1 device cannot utilize intra-band carrier aggregation. Similar tables can be constructed that illustrate allowed carrier aggregation configurations for other bands.

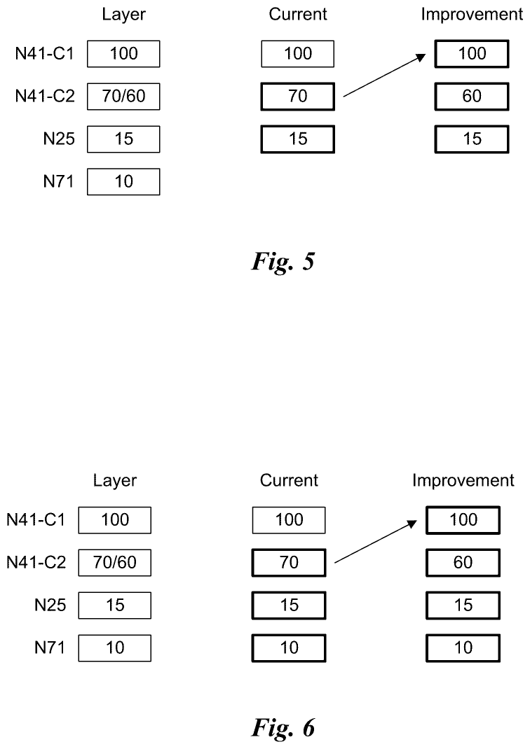

FIG. 5 is a drawing that schematically illustrates three component carrier aggregation according to some implementations. In FIG. 5, a cell site offers four layers: N41-C1 (100 MHz channel bandwidth), N41-C2 (70/60 MHz channel bandwidth, using BWP), N25 (15 MHz channel bandwidth), and N72 (10 MHz channel bandwidth). In current approaches, if a UE attaches using 70 MHz N41 but only supports BCS-1, the device is limited to carrier aggregation using 70 MHz N41 and 15 MHz N25, for a total bandwidth of 85 MHz. That is, the device can utilize inter-band aggregation of N41 at 70 MHz and N25 at 15 MHz but cannot utilize N41 at 100 MHz. In contrast, according to some implementations as described herein, the UE can be handed off to 100 MHz N41, which can be combined with 60 MHz N41 (e.g., partial bandwidth of N41-C2) and 15 MHz N25 for a total bandwidth of 175 MHz.

FIG. 6 is a drawing that schematically illustrates four component carrier aggregation according to some implementations. In FIG. 6, a cell site offers four layers: N41-C1 (100 MHz), N41-C2 (70/60 MHz), N25 (15 MHz), and N72 (10 MHz). As shown in FIG. 6, when a UE with limited connectivity connects using 70 MHz, four component carrier aggregation may not be possible and the UE can be limited to aggregating carriers with 70 MHz, 15 MHz, and 10 MHz channel bandwidths, for a total effective bandwidth of 95 MHz. In contrast, according to some implementations as described herein, the UE can be transitioned to 100 MHz and can utilize 100 MHz, 60 MHz, 15 MHz, and 10 MHz, for an effective bandwidth of 185 MHz.

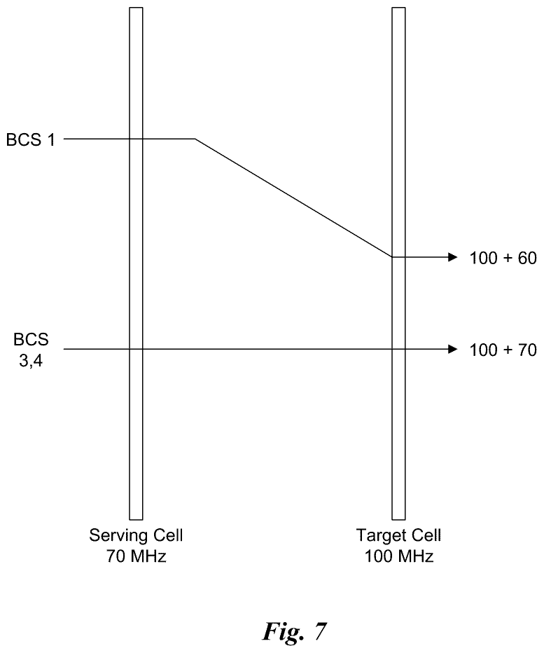

FIG. 7 is a diagram that schematically illustrates NRCA for devices with different supported bandwidth combination sets according to some implementations. In FIG. 7, a device that supports BCS 3 or BCS 4 connects to a serving cell at 70 MHz. Because the device supports BCS 3 or BCS 4, the device can remain connected using 70 MHz and can aggregate 70 MHz and 100 MHz. In contrast, if a BCS 1 device connects at 70 MHz, the device cannot utilize aggregation with 100 MHz. The BCS 1 device can be handed off from 70 MHz channel bandwidth to 60 MHz channel bandwidth, and the 60 MHz and be combined with 100 MHz to deliver a total bandwidth of 160 MHz.

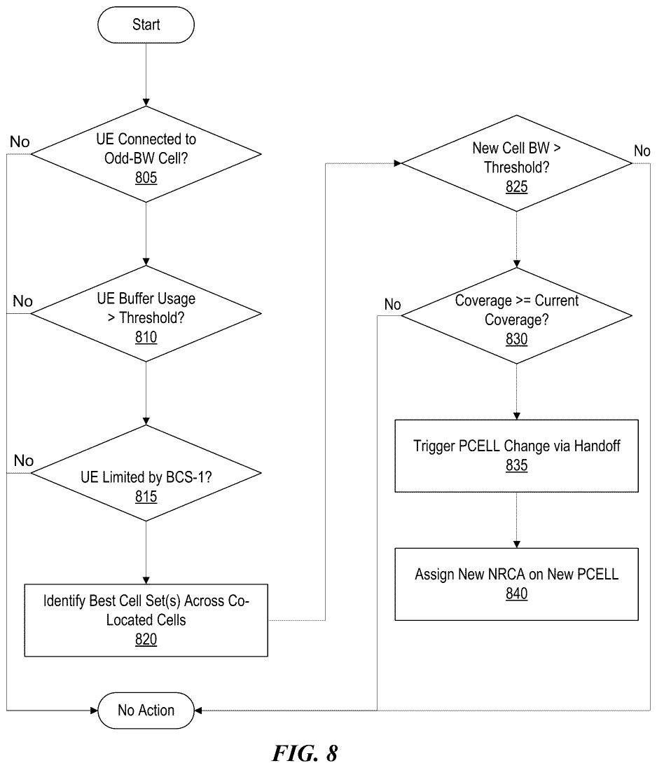

FIG. 8 is a flowchart that illustrates an example NRCA process according to some implementations. As described herein, it can be important to consider more than simply whether or not an NRCA configuration is possible for a UE, as other factors can influence whether or not it would be beneficial to apply a particular NRCA configuration. At operation 805, a system can determine if a UE is connected to an odd-bandwidth carrier. If not, the process can stop. If so, at operation 810, the system can determine if buffer usage by the UE is above a threshold. If not, the process can stop, as the usage of the UE may not be high enough to derive a significant benefit from changing carrier aggregation configuration. If so, the system can, at operation 815, determine if the UE is limited by particular bandwidth combination sets (e.g., BCS-1 for N41). If not, the process can stop. If so, the system can identify the best cell set(s) across one or more co-located cells at operation 820. At operation 825, the system can determine if the available bandwidth identified target cell is greater than a threshold. If not, the process can stop, as changing the carrier aggregation may offer little or no benefit or could even reduce performance for the UE. If so, at operation 830, the system can determine if coverage for the target cell is within a threshold amount of the current cell (e.g., better than or the same as the current cell). The coverage can be determined using, for example, measurement reports for the target cell and the current cell. In some implementations, the system can consider if a coverage area of the target cell is within a threshold amount of the coverage area of the current cell. If not, the process can stop. If so, at operation 835, the system can trigger a cell handoff. At operation 840, the system can assign a new carrier aggregation configuration on the new PCell to the UE.

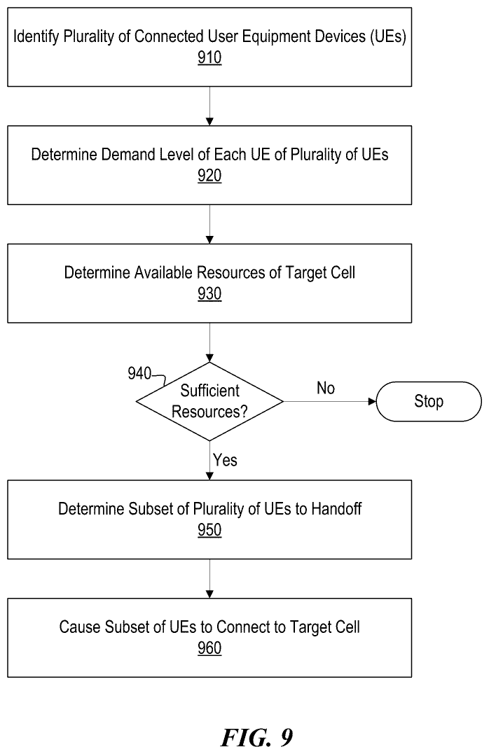

FIG. 9 is a flowchart that illustrates an example process for determining which of a plurality of user equipment (UEs) to hand off to a target cell. At operation 910, a system can identify a plurality of connected UEs. Each UE of the plurality of UEs can be affected by a carrier aggregation limitation that prevents or limits carrier aggregation. For example, each UE of the plurality of UEs can be connected using 70 MHz N41 while being limited to BCS-1. Thus, each UE of the plurality of UEs may be unable to utilize intra-band carrier aggregation. At operation 920, the system can determine a demand level of each UE of the plurality of UEs. For example, some UEs may be placing significant demands on the network such as, for example, by streaming video, engaging in a video conference, uploading or downloading a large file or files, etc. The demand level can be evaluated, for example, according to the process in FIG. 9, for example by considering buffer usage of each UE of the plurality of UEs. At operation 930, the system can determine available resources of a target cell or target cells. The target cell(s) may be able to support all, some, or none of the UEs of the plurality of UEs. That is, handing over a UE to the target cell may provide a significant benefit for none, some, or all of the UEs of the plurality of UEs, for example depending on a current load on the target cell(s). At operation 940, the system can determine if the target cell has sufficient available resources to support handoffs. If not, the process can stop as there is expected to be little or no benefit to handing UEs off to the target cell(s). If so, at operation 950, the system can determine a subset of UEs to hand off to the target cell(s). The determined subset can be based on, for example, network demands by each UE of the plurality of UEs. In some implementations, the system selects UEs for handoff based on the demands of each UE. For example, the system can prioritize the UE with the highest demand and continue with selecting UEs in decreasing order of demand until handing off more UEs would exceed the determined available resources of the target cell(s). It will be appreciated that the available resources can be determined in various manners. In some cases, the determined available resources are determined based on a total capacity of the target cell(s), a currently used capacity of the target cell(s), and a target utilization of the target cell(s). For example, it may be desirable to maintain utilization at or below the target utilization so that resources are available for additional UEs that may connect to the target cell(s), to maintain available capacity when a UE that is connected to the target cell(s) experiences increased demand for network resources, and so forth. At operation 960, the system can cause the subset of UEs to hand off to the target cell. After handoff, the UEs can connect to additional carriers, for example to facilitate intra-band carrier aggregation. As an example, UEs that were connected using 70 MHz N41 can be handed off to 100 MHz N41 and can aggregate with 60 MHz N41.

### Computer System

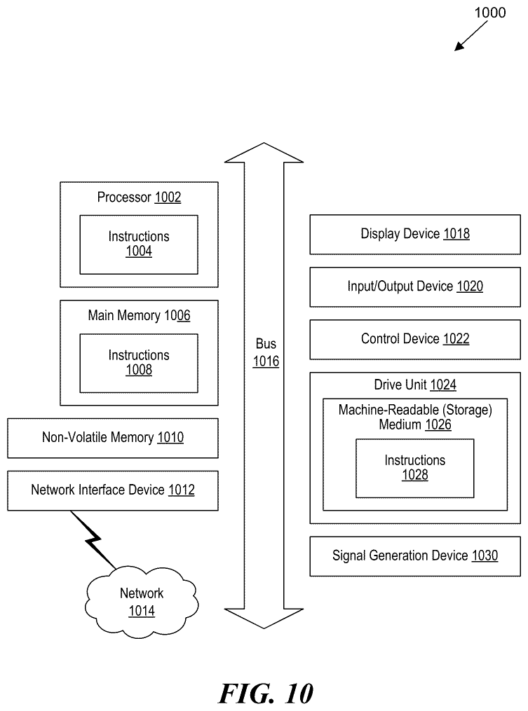

FIG. 10 is a block diagram that illustrates an example of a computer system 1000 in which at least some operations described herein can be implemented. As shown, the computer system 1000 can include: one or more processors 1002, main memory 1006, non-volatile memory 1010, a network interface device 1012, a video display device 1018, an input/output device 1020, a control device 1022 (e.g., keyboard and pointing device), a drive unit 1024 that includes a machine-readable (storage) medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real time, in near real time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for optimized carrier aggregation, the method comprising:
determining a connection of a first user equipment (UE) to a first cell of a wireless telecommunications network;
determining capabilities of the first UE,
wherein the capabilities indicate supported carrier aggregation configurations of a modem of the first UE;
determining a level of network resource demand of the first UE,
wherein the level of network resource demand of the first UE is based at least in part on an amount of buffer usage associated with the first UE;
determining that the network resource demand level is above a threshold network resource demand level;
determining a first band of the connection between the first UE and the first cell;
determining a first channel bandwidth associated with the connection between the first UE and the first cell;
determining, using (1) the capabilities of the first UE, (2) the first band of the connection between the first UE and the first cell, and (3) the first channel bandwidth associated with the connection between the first UE and the first cell, that the first UE is affected by a carrier aggregation limitation,
wherein the carrier aggregation limitation limits intra-band carrier aggregation for the first UE;
identifying one or more candidate cells, wherein the one or more candidate cells are located in a geographic area that at least partially overlaps with a coverage area of the first cell;
selecting a second cell from the one or more candidate cells;
determining that an available capacity of the second cell is greater than a threshold capacity;
determining that a coverage area of the second cell meets a minimum coverage amount,
wherein the minimum coverage amount is based on a coverage area of the first cell;
causing the first UE to connect to the second cell using a second channel bandwidth that is different from the first channel bandwidth; and
assigning a new carrier aggregation configuration to the first UE.

2. The method of claim 1, wherein the first UE is selected from a plurality of UEs connected to the first cell, wherein the first UE is selected by:
determining capabilities for each UE of the plurality of UEs;
determining carrier aggregation limitations for each UE of the plurality of UEs;
determining a network resource demand level of each UE of a subset of the plurality of UEs, wherein the subset of the plurality of UEs comprises UEs that are affected by at least one carrier aggregation limitation; and
selecting the first UE based on a UE of the subset of the plurality of UEs with a highest network resource demand level.

3. The method of claim 1, wherein the first band is an n41 band, wherein the first channel bandwidth is 70 MHz, and wherein the second channel bandwidth is 60 MHz.

4. The method of claim 2, wherein the second cell is configured to utilize bandwidth parts to provide both 70 MHz and 60 MHz channel bandwidths.

5. The method of claim 2, wherein the new carrier aggregation configuration comprises at least n41 with a 60 MHz channel bandwidth and n41 with a 100 MHz channel bandwidth.

6. A method for optimized carrier aggregation, the method comprising:
determining a connection of a first user equipment (UE) to a first cell of a wireless telecommunications network;
determining capabilities of the first UE,
wherein the capabilities indicate supported carrier aggregation configurations of a modem of the first UE;
determining a first band of the connection between the first UE and the first cell;
determining a first channel bandwidth associated with the connection between the first UE and the first cell;
determining, using (1) the capabilities of the first UE, (2) the first band of the connection between the first UE and the first cell, and (3) the first channel bandwidth associated with the connection between the first UE and the first cell, that the first UE is affected by a carrier aggregation limitation,
wherein the carrier aggregation limitation limits intra-band carrier aggregation for the first UE;
identifying one or more candidate cells, wherein the one or more candidate cells are located in a geographic area that at least partially overlaps with a coverage area of the first cell;
selecting a second cell from the one or more candidate cells;
determining that an available capacity of the second cell is greater than a threshold capacity;
determining that a coverage area of the second cell meets a minimum coverage amount;
causing the first UE to connect to the second cell using a second channel bandwidth that is different from the first channel bandwidth; and
assigning a new carrier aggregation configuration to the first UE.

7. The method of claim 6, wherein the first UE is selected from a plurality of UEs connected to the first cell, wherein the first UE is selected by:
determining capabilities for each UE of the plurality of UEs;
determining carrier aggregation limitations for each UE of the plurality of UEs;
determining a network resource demand level of each UE of a subset of the plurality of UEs, wherein the subset of the plurality of UEs comprises UEs that are affected by at least one carrier aggregation limitation; and
selecting the first UE based on a UE of the subset of the plurality of UEs with a highest network resource demand level.

8. The method of claim 6, wherein the first band is an n41 band, wherein the first channel bandwidth is 70 MHz, and wherein the second channel bandwidth is 60 MHz.

9. The method of claim 8, wherein the new carrier aggregation configuration comprises at least n41 with a 60 MHz channel bandwidth and n41 with a 100 MHz channel bandwidth.

10. The method of claim 6, wherein the modem is limited to bandwidth combination set 1 for the n41 band.

11. The method of claim 6, wherein the new carrier aggregation configuration includes intra-band carrier aggregation.

12. The method of claim 6, wherein the new carrier aggregation configuration includes intra-band carrier aggregation and inter-band carrier aggregation.

13. The method of claim 12, wherein the new carrier aggregation configuration includes at least one component carrier configured to operate in time division duplex mode and at least one carrier configured to operate in frequency division duplex mode.

14. The method of claim 6, wherein the capabilities of the first UE are transmitted from the first UE to the first cell.

15. The method of claim 6, wherein the capabilities of the first UE are determined by querying a dataset based on an identifier of the first UE.

16. The method of claim 6, further comprising:
determining a level of network resource demand of the UE,
wherein the level of network resource demand of the UE is based at least in part on an amount of buffer usage associated with the UE; and
determining that the level of network resource demand is above a threshold demand level.

17. The method of claim 6, wherein the minimum coverage amount is that a second coverage area of the second cell is at least as large as a first coverage area of the first cell.

18. A system comprising:
at least one hardware processor; and
at least one non-transitory memory storing instructions, which, when executed by the at least one hardware processor, cause the system to:
determine a connection of a first user equipment (UE) to a first cell of a wireless telecommunications network;
determine capabilities of the first UE,
wherein the capabilities indicate supported carrier aggregation configurations of a modem of the first UE;
determine a first band of the connection between the first UE and the first cell;
determine a first channel bandwidth associated with the connection between the first UE and the first cell;
determine, using (1) the capabilities of the first UE, (2) the first band of the connection between the first UE and the first cell, and (3) the first channel bandwidth associated with the connection between the first UE and the first cell, that the first UE is affected by a carrier aggregation limitation,
wherein the carrier aggregation limitation limits intra-band carrier aggregation for the first UE;
identify one or more candidate cells, wherein the one or more candidate cells are located in a geographic area that at least partially overlaps with a coverage area of the first cell;
select a second cell from the one or more candidate cells;
determine that an available capacity of the second cell is greater than a threshold capacity;
determine that a coverage area of the second cell meets a minimum coverage amount,
wherein the minimum coverage amount is based on a coverage area of the first cell;
cause the first UE to connect to the second cell using a second channel bandwidth that is different from the first channel bandwidth; and
cause a new carrier aggregation configuration to be assigned to the first UE.

19. The system of claim 18, wherein the first UE is selected from a plurality of UEs connected to the first cell, wherein the first UE is selected by:
determining capabilities for each UE of the plurality of UEs;
determining carrier aggregation limitations for each UE of the plurality of UEs;
determining a network resource demand level of each UE of a subset of the plurality of UEs, wherein the subset of the plurality of UEs comprises UEs that are affected by at least one carrier aggregation limitation; and
selecting the first UE based on a UE of the subset of the plurality of UEs with a highest network resource demand level.

20. The system of claim 18, wherein the new carrier aggregation configuration includes intra-band carrier aggregation.
